(19) United States
(12) Patent Application Publication
(10) Pub. No.: US 2013/0175428 A1
(43) Pub. Date: Jul. 11, 2013

(54) Optical Touch Panel Device for Construction Machine

(71) Applicant: Kei Tanaka, Tsuchiura-shi (JP)

(72) Inventor: Kei Tanaka, Tsuchiura-shi (JP)

(73) Assignee: HITACHI CONSTRUCTION MACHINER CO., LTD., Bunkyo-ku, Tokyo (JP)

(21) Appl. No.: 13/818,814

(22) PCT Filed: Sep. 2, 2011
(86) PCT No.: PCT/JP2011/070053

§ 371 Date: Feb. 25, 2013

(30) Foreign Application Priority Data
Sep. 30, 2010 (JP) 2010-222195

(51) Int. Cl. G06F 3/042

(52) U.S. Cl. CPC G06F 3/0421
USPC 250/206.1

(57) ABSTRACT

An optical touch panel device for a construction machine capable of preventing the occurrence of a detection defect of a tactile contact point caused by external light falling upon a light-receiving element is provided with a planar panel with which tactile contact is made by an operator, light-emitting elements which emit light rays along the surface of the panel, and light-receiving elements which are provided to be paired with the light-emitting elements respectively so as to receive the light rays. The light-emitting elements are arranged so that the three light rays can intersect at each of a plurality of predetermined points upon a plane which is parallel to the panel, so that simultaneous interruption of at least two of the intersecting three light rays can be detected as tactile contact at a point of the surface of the panel facing the predetermined point.

### TECHNICAL FIELD

The present invention relates to an optical touch panel device provided with a planar panel with which tactile contact is made by an operator, a plurality of light-emitting elements which emit light rays along the surface of the panel, and a plurality of light-receiving elements which are provided to be paired with these light-emitting elements respectively so as to receive the light rays, so that tactile contact with the panel made by the operator can be detected based on interruption of the light rays emitted from the light-emitting elements toward the light-receiving elements.

### BACKGROUND ART

An optical touch panel device according to the background art is provided with a planar panel with which tactile contact is made by an operator, a plurality of light-emitting elements which emit light rays along the surface of the panel, and a plurality of light-receiving elements which are provided to be paired with these light-emitting elements respectively so as to receive the light rays. The light-emitting elements are arranged so that two light rays can intersect at each of a plurality of predetermined points in a plane which is parallel to the panel. That is, in the optical touch panel device according to the background art, simultaneous interruption of the intersecting two light rays is detected as tactile contact made by the operator at a point of the surface of the panel which faces the predetermined point. (See Patent Document 1)

### CITATION LIST

### Patent Literature

Patent Literature 1: JP-A-11-353102

### SUMMARY OF INVENTION

### Technical Problem

Glass windows are provided in a front surface, a back surface and left and right opposite side surfaces of a cab of a construction machine, and the front-to-back and left-to-right width dimensions of the cab are designed based on the formation of a space in which only one operator can ride. Therefore, external light such as sunlight and reflected light thereof, illumination light during night construction and reflected light thereof, etc. may fall into the cab easily. When it is considered that the aforementioned optical touch panel device according to the background art is installed in such a cab of a construction machine, it is likely that external light may fall into the light-receiving elements. That is, external light may fall upon one of two light-receiving elements receiving two light rays intersecting at a predetermined point, so that a finger of an operator put at the predetermined point, that is, tactile contact made by the operator at a point of the surface of the panel which faces the predetermined point cannot be detected. Thus, the occurrence of such a detection defect may be troubled about.

The present invention has been accomplished in consideration of the aforementioned circumstances. An object of the invention is to provide an optical touch panel device for a construction machine capable of preventing the occurrence of a detection defect of a tactile contact point caused by external light falling upon a light-receiving element.

### Solution to Problem

In order to achieve the aforementioned object, an optical touch panel device for a construction machine according to the present invention is configured as follows.

[1] An optical touch panel device for a construction machine according to the present invention includes: a planar panel with which tactile contact is made by an operator; a plurality of light-emitting elements which emit light rays along a surface of the panel; and a plurality of light-receiving elements which are provided to be paired with these light-emitting elements respectively so as to receive the light rays, the optical touch panel device being installed in a cab of the construction machine, the optical touch panel device being characterized in that: the plurality of light-emitting elements are arranged so that three or more of the light rays can intersect at each of a plurality of predetermined points upon a plane which is parallel to the panel, and simultaneous interruption of at least two of the intersecting three or more light rays is detected as tactile contact made by the operator at a point of the surface of the panel which faces the predetermined point.

In the optical touch panel device for a construction machine according to the “[1]”, simultaneous interruption of at least two of the intersecting three or more light rays is detected as tactile contact made by the operator at a point of the surface of the panel which faces the predetermined point. Thus, the tactile contact made by the operator at the point of the surface of the panel which faces the predetermined point can be detected if there are two light-receiving elements upon which external light does not fall even when there is a light-receiving element on which external light is incident among the light-receiving elements receiving the intersecting three or more light rays respectively. As a result, it is possible to prevent the occurrence of a detection defect of the tactile contact point caused by the external light falling upon the light-receiving element.

[2] A touch panel device for a construction machine according to the present invention is a touch panel device for a construction machine according to the “[1]”, characterized in that: the touch panel device further includes a cover member located to cover a surface of each of the light-receiving elements which receives corresponding one of the light rays; and a slit is provided in the cover member so that the slit can guide the light ray from the light-emitting element paired with the light-receiving element while blocking incidence of the light rays from the other light-emitting elements which are not paired with the light-receiving element onto the light-receiving element.

In the touch panel device for a construction machine according to the “[2]”, the occurrence of a detection defect caused by light rays received from light-emitting elements by a light-receiving element which is not paired with the light-emitting elements can be prevented by the slit.

### Advantageous Effects of Invention

According to the touch panel device for a construction machine according to the present invention, it is possible to prevent the occurrence of a detection defect of a tactile contact point caused by external light falling on a light-receiving element as described above.

### BRIEF DESCRIPTION OF DRAWINGS

FIG. 1 A side view of a construction machine according to an embodiment of the present invention.

FIG. 2 A perspective view showing the state viewed ahead of an operator's seat in a cab shown in FIG. 1.

FIG. 3 A view showing the alignment of light-emitting elements and light-receiving elements provided in an optical touch panel device according to an embodiment of the present invention shown in FIG. 2, and an infrared matrix formed by these light-emitting elements and these light-receiving elements.

FIG. 4 A simplified view showing combinations of light-receiving elements and light-emitting elements used for detecting an operator's finger making tactile contact with a panel shown in FIG. 3.

FIG. 5 A view showing an effective range of an incident angle of an infrared ray received by a light-receiving element.

FIG. 6 A view showing intersecting angles among three light rays.

### DESCRIPTION OF EMBODIMENTS

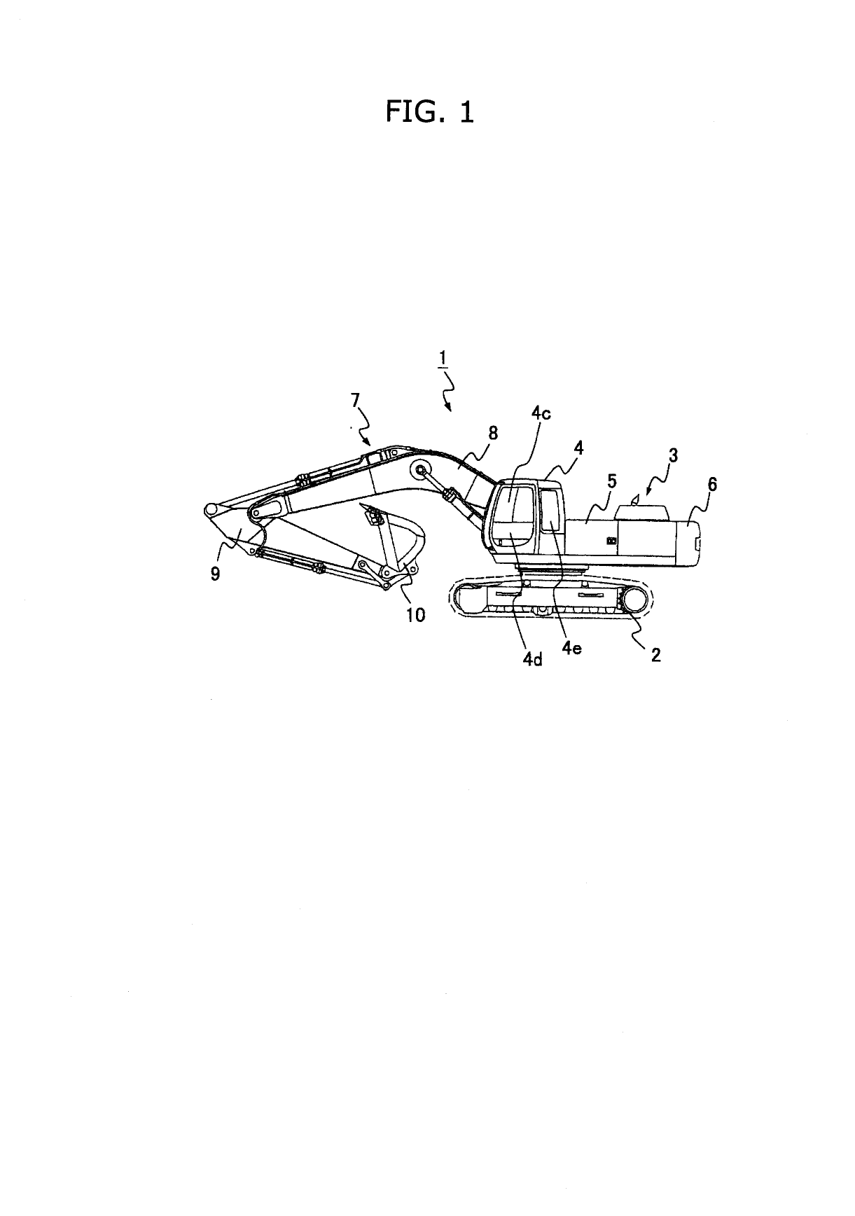

An optical touch panel device for a construction machine according to an embodiment of the present invention will be described with reference to FIGS. 1 to 6.

A construction machine 1 (hydraulic excavator) shown in FIG. 1 has a traveling body 2 by use of which the construction machine 1 can travel, a slewing structure 3 which is a body of the construction machine 1 and which is coupled with the traveling body 1 slewably, and a front work device 7 provided in a front portion of the slewing structure 3. The slewing structure 3 includes a cab 4 which is located on the left side of the front work device 7, a machine room 5 which is provided at the rear of the cab 4, and a counter weight 6 which is provided at the rear of the machine room 5. The front work device 7 includes a boom 8 which is coupled with the slewing structure 3 rotatably, an arm 9 which is coupled with the boom 8 rotatably, and a bucket 10 which is coupled with the arm 9 rotatably.

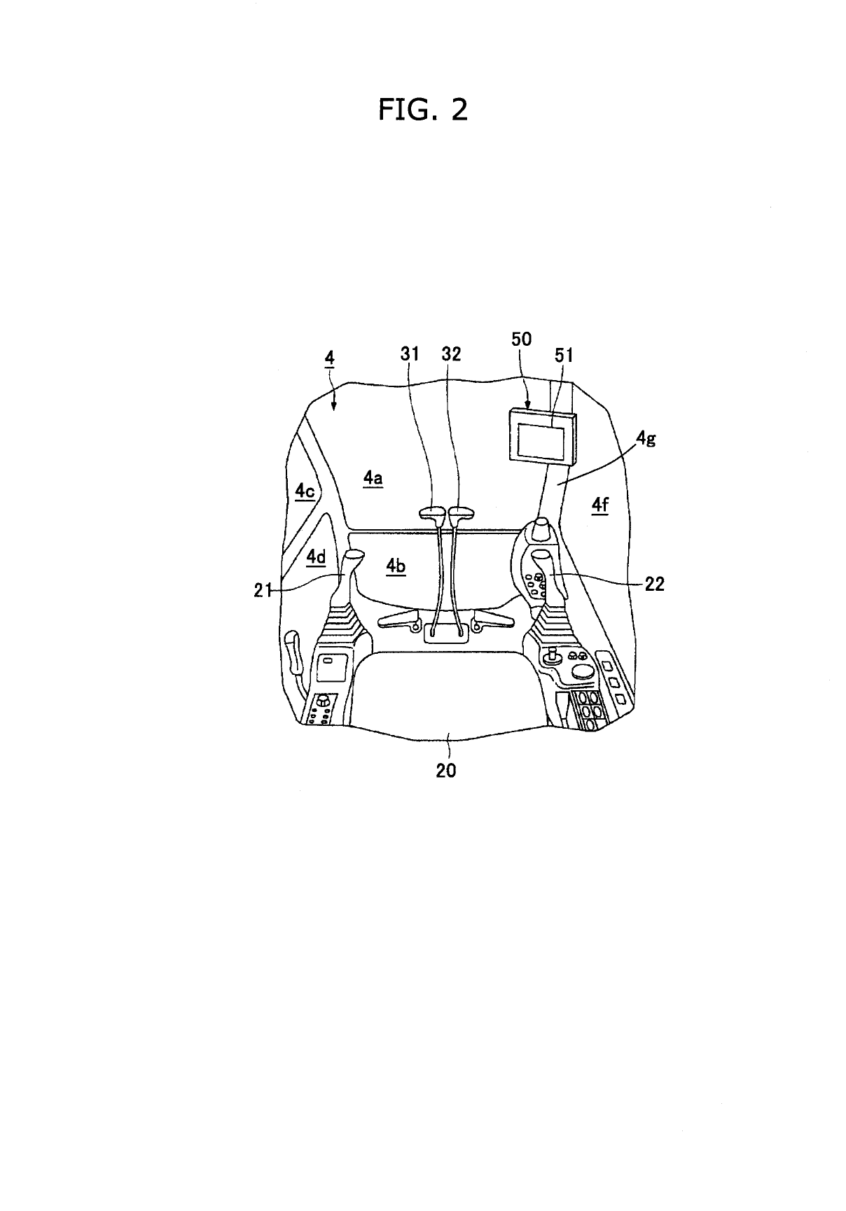

As shown in FIG. 2, an operator's seat 20, operation levers 21 and 22 disposed in left and right opposite side portions of the operator's seat 20 respectively, and operation levers 31 and 32 disposed in front of the operator's seat 20 and erectly on the floor are provided in the cab 4.

Glass windows 4a and 4b are provided in a front surface of the cab 4 so as to be placed one above the other. The glass windows 4a and 4b account for almost the whole of the front surface of the cab 4. A boarding door (see FIG. 1) is provided in a left side surface of the cab 4 and obliquely in front of the operator's seat 20. Glass windows 4c and 4d are provided in the boarding door so as to be placed one above the other. A glass window 4e (see FIG. 1) is provided in the left side surface of the cab 4 and on the left side of the operator's seat 20. A glass window 4f is provided in a right side surface of the cab 4. The glass window 4f accounts for almost the upper half of the right side surface of the cab 4. A not-shown glass window is also provided in a back surface of the cab 4. During the daytime, sunlight or reflected light thereof falls into the cab 4 through these glass windows 4a to 4f etc. At night, illumination light and reflected light thereof fall likewise.

A monitor unit 50 for displaying information about the operating condition of the construction machine 1 is provided on a pillar 4g located at a right front corner in the cab 4. The monitor unit 50 has a rectangular display window 51. The display window 51 is fixed to the pillar 4g so as to look toward the operator's seat 20 while one pair of opposite sides (opposite side pair consisting of long sides in this embodiment) of the display window 51 is arranged one above the other.

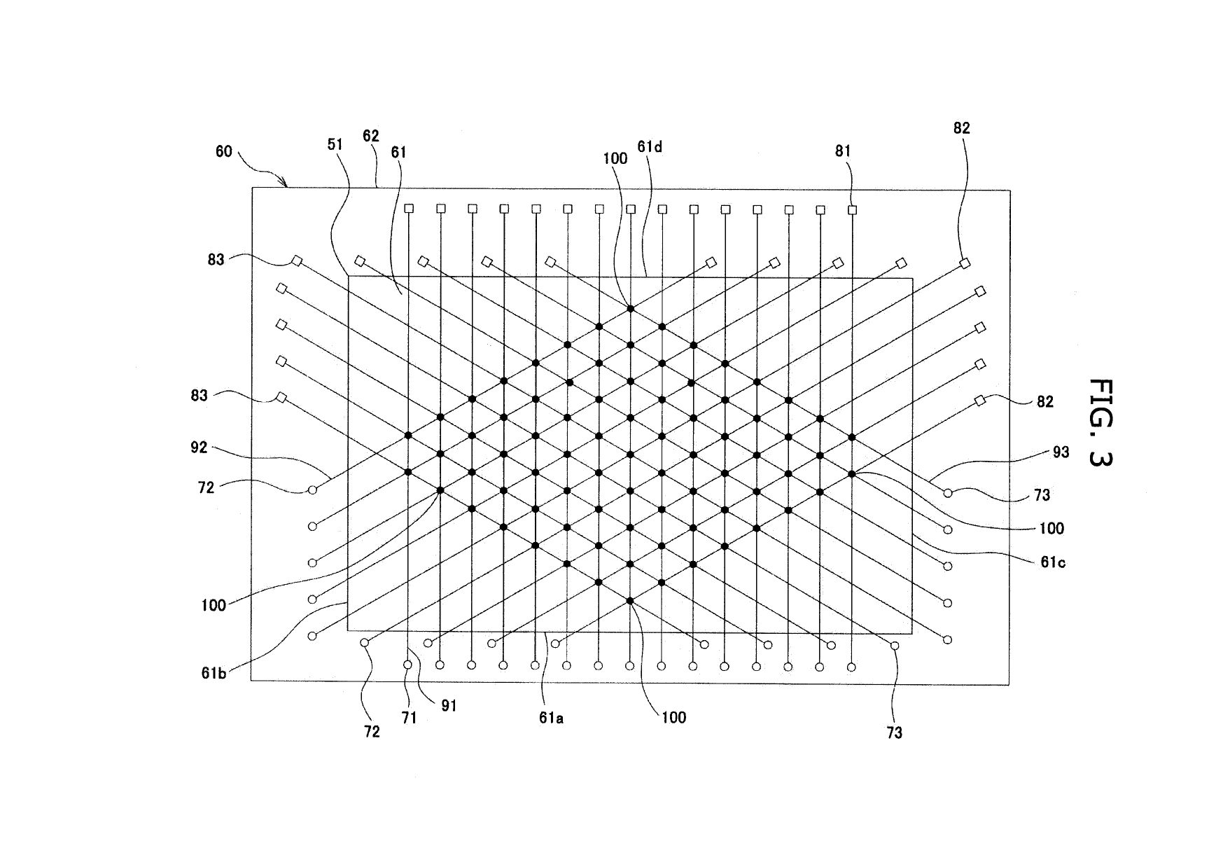

As shown in FIG. 3, the display window 51 is formed out of a touch panel device 60 according to this embodiment. That is, the touch panel device 60 has a panel 61 which is formed into a rectangular shape out of a transparent planar acrylic plate and with which tactile contact is made by the operator, a frame member 62 to which the panel 61 is fixed, and light-emitting elements 71 to 73 and light-receiving elements 81 to 83 which are received in the frame member 62. Each light-emitting element 71 is an infrared LED which emits one light ray 91 (infrared ray) in a direction from bottom to top along the surface of the panel 61. Each light-emitting element 72 is an infrared LED which emits one light ray 92 (infrared ray) in a direction from lower left to upper right along the surface of the panel 61. Each light-emitting element 73 is an infrared LED which emits one light ray 93 (infrared ray) along the surface of the panel 61. The light-receiving elements 81 to 83 are phototransistors which are provided to be paired with the light-emitting elements 71 to 73 respectively so that each of the light-receiving elements 81 to 83 can receive corresponding one of the light rays 91 to 93.

The light-emitting elements 71 to 73 are arranged so that the three light rays 91 to 93 can intersect at each of a plurality of predetermined points 100 upon a plane which is parallel to the panel 61. Specifically, the light-emitting elements 71 are arrayed along a lower side 61a of the rectangular panel 61 so as to emit the light rays 91 extending perpendicularly to the long sides of the panel 61. The light-emitting elements 72 consist of light-emitting elements arrayed along a left side 61b of the panel 61 in a range under the center of the left side 61b and light-emitting elements arrayed along the lower side 61a of the panel 61 in a range on the left side of the center of lower side 61a, in order to emit the light rays 92 extending in a direction from lower left to upper right along the panel 61. The light-emitting elements 73 consist of light-emitting elements arrayed along a right side 61c of the panel 61 in a range under the center of the right side 61c and light-emitting elements arrayed along the lower side 61a of the panel 61 in a range on the right side of the center of lower side 61a, in order to emit the light rays 93 extending in a direction from lower right to upper left along the panel 61. The light-emitting elements 72 and 73 are disposed to be closer to the lower side 61a of the panel 61 than the light-emitting elements 71. The light-receiving elements 81 to 83 are arrayed so that the panel 61 can be put between the light-receiving elements 81 to 83 and the light-emitting elements 71 to 73. The light-receiving elements 82 and 83 are disposed to be closer to an upper side 61d of the panel 61 than the light-emitting elements 71.

The light-emitting elements 71 to 73 are disposed on the lower side of the panel 61, and the light-receiving elements 81 to 83 are disposed on the upper side of the panel 61. Thus, external light like sunlight falling obliquely downward into the cab 4 can be prevented from being incident on the light-receiving elements 81 to 83.

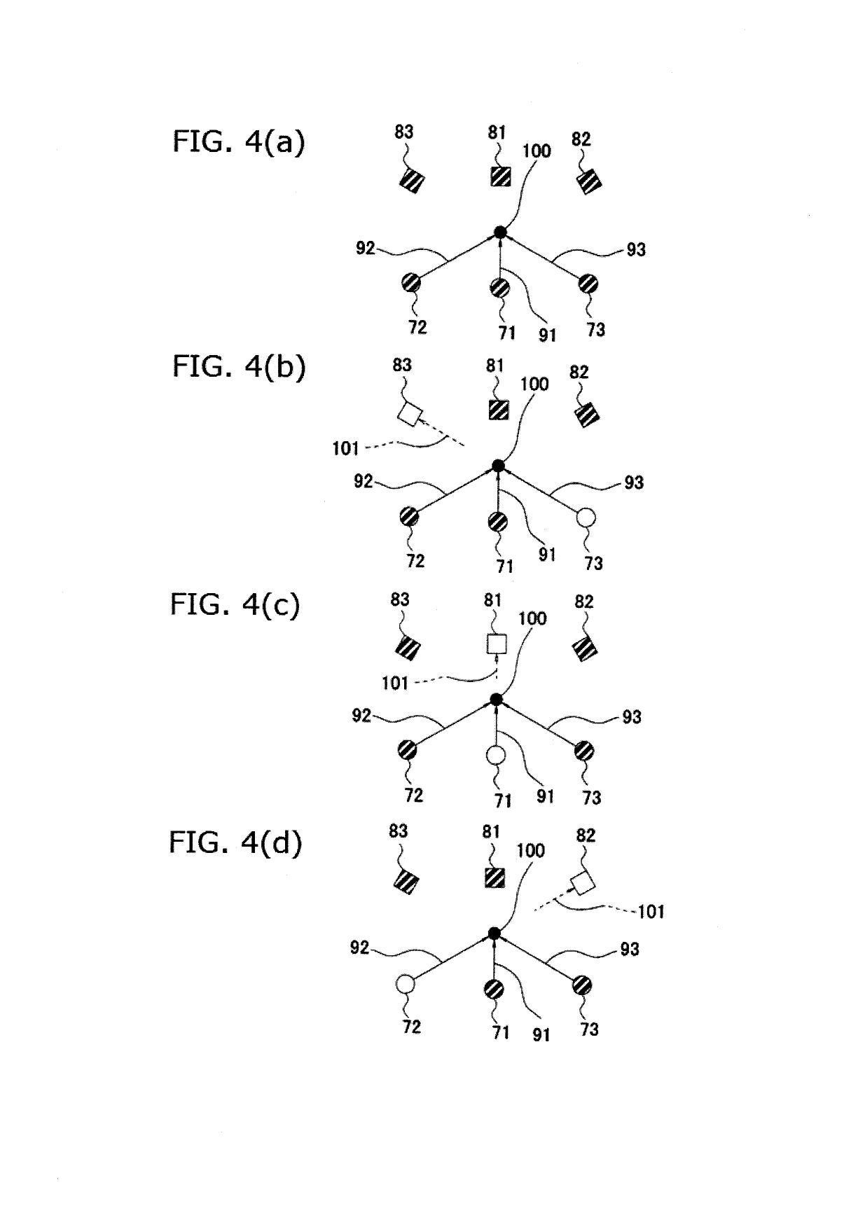

The touch panel device 60 is designed so that simultaneous interruption of at least two of the intersecting three light rays 91 to 93 can be detected as tactile contact made by the operator at a point of the surface of the panel 61 which faces a specific point of the predetermined points 100. Next, this will be described in detail with reference to FIG. 4.

Assume that each light-receiving element 81 receives the light ray 91 from the corresponding light-emitting element 71, each light-receiving element 82 receives the light ray 92 from the corresponding light-emitting element 72, and each light-receiving element 83 receives the light ray 93 from the corresponding light-emitting element 73, while no external light is incident on any of the light-receiving elements 81 to 83. When a finger of an operator is put on any one of the predetermined points 100 in such a state, all the three light rays 91 to 93 traveling toward the light-receiving elements 81 to 83 are interrupted by the finger as shown in FIG. 4(a). Thus, the finger of the operator put on the predetermined point 100 can be detected.

On the other hand, assume that each light-receiving element 81 receives the light ray 91 from the corresponding light-emitting element 71, each light-receiving element 82 receives the light ray 92 from the corresponding light-emitting element 72, and each light-receiving element 83 receives the light ray 93 from the corresponding light-emitting element 73, while external light 101 is incident on the light-receiving element 83 of the light-receiving elements 81 to 83. When a finger of an operator is put on a predetermined point 100 in such a state, all the three light rays 91 to 93 traveling toward the light-receiving elements 81 to 83 are interrupted by the finger but the external light 101 is kept incident on the light-receiving element 83 as shown in FIG. 4(b). Thus, the light-receiving element 83 cannot detect the interruption of the light ray 93. In this case, the two light-receiving elements 81 and 82 detect the interruption of the light rays 91 and 92 respectively. Thus, the finger of the operator put on the predetermined point 100 can be detected.

In the same manner as this, assume that each light-receiving element 81 receives the light ray 91 from the corresponding light-emitting element 71, each light-receiving element 82 receives the light ray 92 from the corresponding light-emitting element 72, and each light-receiving element 83 receives the light ray 93 from the corresponding light-emitting element 73, while external light 101 is incident on the light-receiving element 81 of the light-receiving elements 81 to 83. When a finger of an operator is put on a predetermined point 100 in such a state, all the three light rays 91 to 93 traveling toward the light-receiving elements 81 to 83 are interrupted by the finger but the external light 101 is kept incident on the light-receiving element 81 as shown in FIG. 4(c). Thus, the light-receiving element 81 cannot detect the interruption of the light ray 91. In this case, the two light-receiving elements 82 and 83 detect the interruption of the light rays 92 and 93 respectively. Thus, the finger of the operator put on the predetermined point 100 can be detected.

In the same manner as this, assume that each light-receiving element 81 receives the light ray 91 from the corresponding light-emitting element 71, each light-receiving element 82 receives the light ray 92 from the corresponding light-emitting element 72, and each light-receiving element 83 receives the light ray 93 from the corresponding light-emitting element 73, while external light 101 is incident on the light-receiving element 82 of the light-receiving elements 81 to 83. When a finger of an operator is put on a predetermined point 100 in such a state, all the three light rays 91 to 93 traveling toward the light-receiving elements 81 to 83 are interrupted by the finger but the external light 101 is kept incident on the light-receiving element 82 as shown in FIG. 4(d). Thus, the light-receiving element 82 cannot detect the interruption of the light ray 92. In this case, the two light-receiving elements 81 and 83 detect the interruption of the light rays 91 and 93 respectively. Thus, the finger of the operator put on the predetermined point 100 can be detected.

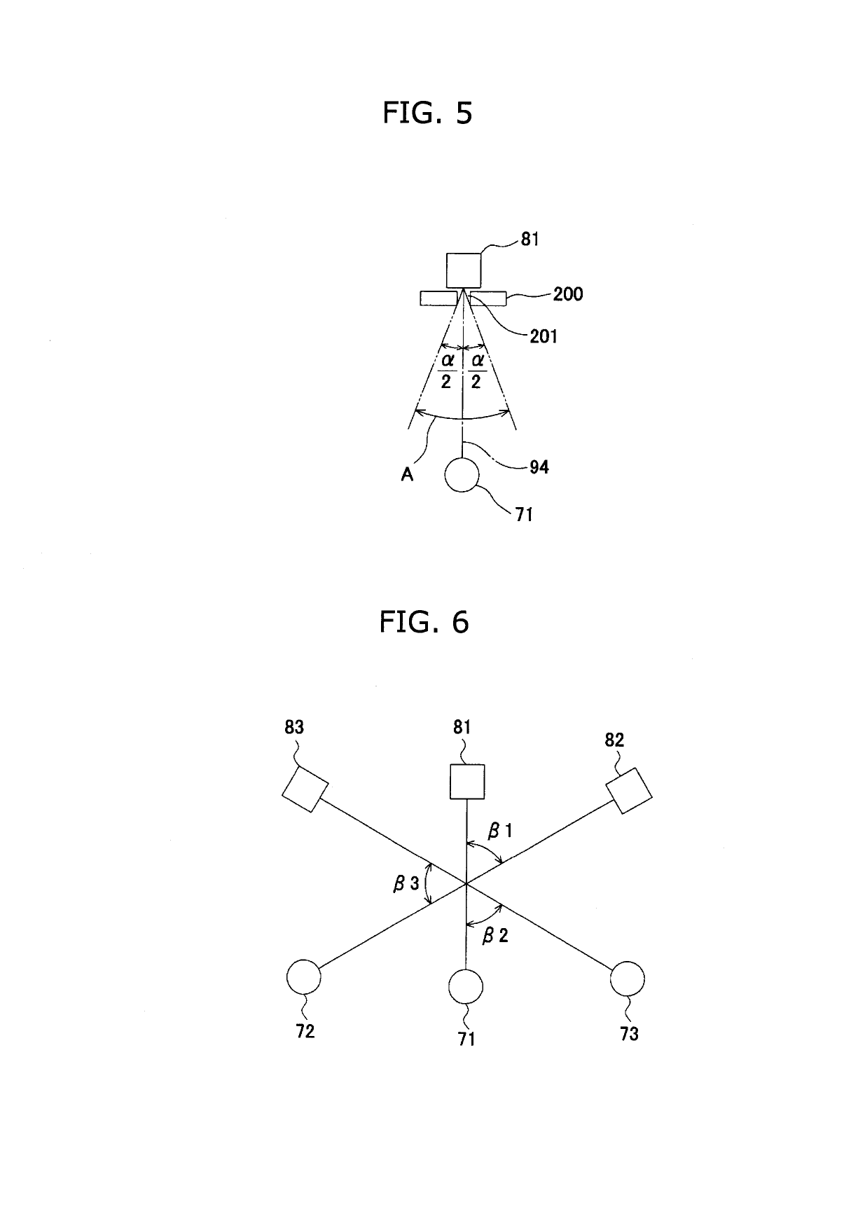

As shown in FIG. 5, the surface of each light-receiving element 81 which receives the light ray 91 is covered with a cover member 200 (which is not shown in FIGS. 3 and 4). A slit 201 is provided in the cover member 200. The slit 201 defines an effective range A of an incident angle with which the light-receiving element 81 can detect the light ray 91. The effective range A corresponds to a range of ±α/2 from 0° when a virtual line 94 (alternate long and short dash line) connecting the light-emitting element 71 and the light-receiving element 81 is set at 0°. A cover member 200 with a slit 201 is provided for each light-emitting element 82, 83 (not shown). All an angle β1 with which the light rays 91 and 92 intersect, an angle β2 with which the light rays 91 and 93 intersect and an angle β3 with which the light rays 92 and 93 intersect, as shown in FIG. 6, are set to be larger than the angle α. That is, the slit 201 for the light-receiving element 81 guides the light ray 91 from the light-emitting element 71 paired with the light-receiving element 81 while blocking the incidence of the light rays 92 and 93 from the light-emitting elements 72 and 73 which are not paired with the light-receiving element 81. Although setting is done as “α=30° and β1=β2=β3=60°” in this embodiment, the angles β1 to β3 may be different from one another or one of those angles may be different from the other angles as long as the angles β1 to β3 are larger than the angle α.

According to the optical touch panel device 60 according to this embodiment, the following effects can be obtained.

In the optical touch panel device 60, simultaneous interruption of at least two of the intersecting three light rays 91 to 93 is detected as tactile contact made by the operator at a point of the surface of the panel 61 which faces the predetermined point 100. That is, the tactile contact made by the operator at the point of the surface of the panel 61 which faces the predetermined point 100 can be detected if there are two light-receiving elements on which external light is not incident even when there is a light-receiving element on which external light is incident among the light-receiving elements receiving the intersecting three light rays 91 to 93 respectively. As a result, it is possible to prevent the occurrence of a detection defect of the tactile contact point caused by the external light falling upon the light-receiving element.

In the optical touch panel device 60, the occurrence of a detection defect caused by light rays received from light-emitting elements by each light-receiving element 81 to 83 which is not paired with the light-emitting elements can be prevented by the slit 201.

### REFERENCE SIGNS LIST

1 construction machine
2 traveling body
3 slewing structure
4 cab
4a to 4f glass window
4g pillar
5 machine room
6 counter weight
7 front work device
8 boom
9 arm
10 bucket
20 operator's seat
21, 22, 31, 32 operation lever
50 monitor unit
51 display window
6 touch panel device
61 panel
61a lower side
61b left side
61c right side
61d upper side
62 frame member
71 to 73 light-emitting element
81 to 83 light-receiving element
91 to 93 light ray
94 virtual line
100 predetermined point
101 external light
200 cover member
201 slit

1. An optical touch panel device for a construction machine comprising: a planar panel with which tactile contact is made by an operator; a plurality of light-emitting elements which emit light rays along a surface of the panel; and a plurality of light-receiving elements which are provided to be paired with the light-emitting elements respectively so as to receive the light rays, the optical touch panel device being installed in a cab of the construction machine, the optical touch panel device being characterized in that:
the plurality of light-emitting elements are arranged so that three or more of the light rays can intersect at each of a plurality of predetermined points upon a plane which is parallel to the panel; and
simultaneous interruption of at least two of the intersecting three or more light rays is detected as tactile contact made by the operator at a point of the surface of the panel which faces the predetermined point.

2. A touch panel device for a construction machine according to claim 1, characterized in that:
the touch panel device further comprises a cover member located to cover a surface of each of the light-receiving elements which receives corresponding one of the light rays; and
a slit is provided in the cover member so that the slit can guide the light ray from the light-emitting element paired with the light-receiving element while blocking incidence of the light rays from the other light-emitting elements which are not paired with the light-receiving element onto the light-receiving element.
